(19) United States
(12) Patent Application Publication
(10) Pub. No.: US 2004/0133465 A1
(43) Pub. Date: Jul. 8, 2004

(54) Printed matter dispatching system, printed matter dispatching method, printed matter dispatching server, request accepting server, and storage medium

(76) Inventors: Siro Koge, Tottori (JP); Yuichi Sakae, Tokyo (JP)

Correspondence Address: Oliff & Berridge, P O Box 19928, Alexandria, VA, 22320, US

(21) Appl. No.: 10/111,848

(22) PCT Filed: Sep. 5, 2001
(86) PCT No.: PCT/JP01/07688

(30) Foreign Application Priority Data
Sep. 5, 2000 (JP) 2000-309906
Dec. 28, 2000 (JP) 2000-401325

(51) Int. Cl. G06F 17/60

(52) U.S. Cl. 705/14

(57) ABSTRACT

It is capable of providing a printed matter dispatching system wherein, a printed matter dispatching system 1 comprising a multiplicity of terminals 2 and printed matter dispatching server 3 that is connected to said multiplicity of terminals 2 via network 5, a printed matter dispatching server 3 that comprises an advertising database 7 that stores a multiplicity of advertising data, as well as executes a process that receives dispatch request information from terminals 2, and a process that extracts advertising data from advertising data base 7 in accordance with received dispatch request information, and a process that prints designated data included in the dispatch request information and extracted advertising data onto a postcard in an integrated manner, allows the sender who sends postcards, etc., to simplify the dispatching operation as well as reduce the dispatching cost, while at the same time, advertisers who put advertising on postcards can simplify the dispatching operation as well as improve the advertising effect.

A printed matter dispatching system, printed matter dispatching method, printed matter dispatching server, request receiving server and a storage medium.

1. Field of Invention

The present invention pertains to the fields of printed matter dispatching systems, printed matter dispatching methods, printed matter dispatching servers, request receiving servers and storage mediums in which the dispatching of printed matter is carried out using multiple terminals, a printed matter dispatching server, a request receiving server, etc., that are connected through a network such as the Internet.

2. Prior Art

Currently, along with the popularization of the Internet and mobile phones, the modes of communication have diversified. Postcards, which are an existing mode of communication still have a high utilization rate, and have been used in a wide range of applications such as personal correspondence, new year's cards, summer greetings and direct mail.

In general, sending a postcard (handwritten) requires the following operations to be carried out.

(1) Purchase a postcard and stamp (or pre-stamped postal card).

(2) Fill out the backside of the postcard with the communication such as writing.

(3) Fill out the front side of the postcard with, for example, the sender's address and name and the recipient's address and name.

(4) Drop the completed postcard into a mailbox.

In addition, the sending of a printed postcard of, for example, a photo requires the following operations to be carried out.

(1) Purchase a postcard (special paper, etc.) and stamp (or pre-stamped postal card).

(2) Print the photos, etc., on the backside of the postcard and fill in the writing as required.

(3) Fill out or print, for example, the sender's address and name and the recipient's address and name on the front side of the postcard.

(4) Drop the completed postcard into a mail box.

Furthermore, the sending of direct mail normally requires the following operations.

(1) Print the ad, which has been prepared in advance on postcards.

(2) Collect data about the addressees (recipients) and narrow down the list to the addressees with the highest potential advertising effect.

(3) Print the address and name, etc., of the recipients on the front side of the postcards.

(4) Bring the completed direct mail to the post office and mail them as bulk mail, etc.

The dispatching of a postcard is not only troublesome as described above, but also generates costs such as for stamps (postal card fees), etc., therefore, it has been difficult to conduct easy and inexpensive information communication such as communication on the Internet (electronic mail, etc.). In addition, sending a printed postcard with photos, etc., requires the preparation of a printer, special paper and inks in advance, causing the problems of having inconveniences and costs compared to the handwritten case. Moreover, sending direct mail requires the generation of a name list purchasing fee in addition to the advertising production costs, printing costs and postal fees, and therefore, sometimes the number dispatched may be limited due to the high unit price of the dispatching. In addition, normally direct mail has a low rate of being thoroughly read and kept, and therefore, even if it has well thought out advertising, a great improvement in the advertising effect cannot be expected.

### DISCLOSURE OF THE INVENTION

The present invention was created in order to solve these problems by taking the above-mentioned conditions into account. It is a printed matter dispatching system comprising a multiplicity of terminals, and a printed matter dispatching server connected to said multiplicity of terminals via a network, wherein, said printed matter dispatching server comprises an advertising data storage means that stores a multiplicity of advertising data, a dispatch request information receiving means that receives requests for dispatching information from said terminals, an advertising data extracting means that extracts the advertising data from said advertising data storage means in accordance with said dispatch request information, and an integrating printing means that prints the designated data contained in said dispatch request information and said extracted advertising data on the dispatching medium in an integrated manner. In other words, in the case of sending a dispatching medium such as a postcard, a request for dispatching is made to the printed matter dispatching server from the terminal at hand, the printed matter dispatching server prints the designated data contained in the dispatch request information on the dispatching medium, and sends it out, and therefore, the requester of the dispatching can avoid inconveniences such as purchasing postcards, and dropping them off at the mail box. In addition, the dispatching medium is printed with advertising data in an integrated manner, allowing the printed matter dispatching service to be provided inexpensively or free of charge because the administrator of the printed matter dispatching server charges an advertising fee to the advertiser. Furthermore, because it is a postcard from an acquaintance, it not only has a high probability that the recipients will thoroughly read the advertising but also will keep it. As a result, a great improvement in the advertising effect can be possible. Moreover, the requester of the dispatch can select the advertising data to be printed in an integrated manner based on the recipient's attribute information such as the address, age, gender, occupation or interests allowing a further improved advertising effect.

In addition, said printed matter dispatching server has the characteristic of having a request screen data transmission means that transmits the request screen data to have said dispatch request information be entered, to said terminal. In other words, the dispatching request can be carried out on the dedicated request screen displayed on a personal computer or mobile phone, allowing further simplification of the sending operation of postcards, etc.

Furthermore, it has the characteristic that said request screen data is comprised of at least the sender's data entry means, the recipient's data entry means and the communication data entry means. In other words, the essential data for sending a postcard, etc., can be obtained, as well as the image data can be entered as communication data, allowing the sending of postcards printed with photos, illustrations, and handwritten writings, etc., from an environment without a printer.

Moreover, said printed matter dispatching system further comprises a request receiving server that is connected to said terminals and said printed matter dispatching server, and said request receiving server comprises a request screen data transmission means that transmits said request screen data to said terminals, and a dispatching information reception means that receives the dispatching request information from said terminals, and a dispatch request forwarding means that forwards said received dispatch request information to said printed matter dispatching server. In other words, through a variety of sites existing on networks such as the Internet, a dispatching request can be received. A great increase in the number of dispatching requests can be expected when the dispatching request is received, in particular at a site that provides communication (community site). Furthermore, by forwarding the address data kept by the request receiving server, the entry operation of the requester of the dispatching can be significantly simplified.

In addition, said printed matter dispatching server is characterized by being further comprised of a dispatch history saving means that saves a recipient's data by relating it to the requester of the dispatching, and a list screen data transmission means that transmits the list screen data of the dispatch history that corresponds to the request from said terminals. In other words, the dispatch history can be listed on the screen, so that when the postcard is sent again to a once dispatched recipient, the entry operation of the requester of the dispatching can be significantly simplified.

Furthermore, said printed matter dispatching server is characterized by being further comprised of a log-on screen data transmission means that transmits a log-on screen data request for entry of at least a password, when a transmission request for said list screen data is received from said terminals, and transmission authorization means that authorizes the transmission of said list screen data in the case the entry password is correct. In other words, list screen data is transmitted after validation of the user, so that leakage of the dispatch history, which is personal information, can be prevented.

Additionally said printed matter dispatching server is characterized by being further comprised of a recipient selection entry means that uses the selected recipient data on the list screen of the dispatch history to be the current recipient data for the dispatch request information. In other words, selecting a recipient on the list screen of the dispatch history eliminates the re-entering of a recipient's data allowing a significant simplification of the entry operation of the requester of the dispatching.

Beyond that, said printed matter dispatching server is characterized by being further comprised of an attribute information entry request means that requests the entry of attribute information from the recipient even in the case the selected recipient data on the list screen of the dispatch history is used as the current recipient data of the dispatch request information. In other words, the latest attribute information about the recipient can be obtained so that higher conformity to the advertising data can be obtained compared to the case the advertising data is extracted based on the attribute information entered in the past.

Moreover, said printed matter dispatching server is characterized by being further comprised of a preview screen data transmission means that transmits preview screen data to display the content of the printing prior to the execution of the printing of the dispatching medium by said integrating printing means, to said terminals. In other words, the content of the printout can be checked prior to the dispatching, allowing the entry mistakes in the dispatch request information, etc., to be easily found. In addition, when a preview of the content of advertising is displayed, the requester of the dispatching can select the advertising or reject inappropriate advertising.

Furthermore, said preview screen data is characterized by comprising a process selection means that selects the printing execution process, the printing cancellation process, or the printing content correction process. In other words, depending on the printing content in the preview, a later process can be selected thereby improving the convenience to the requester of the dispatching.

In addition, said dispatching medium is characterized by being a postcard or a letter. In other words, by printing advertising in an integrated manner on postcards and letters that have a high usage rate, a very large advertising medium can be constructed.

Moreover, said integrating printing means is characterized by printing a lottery number on the dispatching medium. In other words, the dispatching medium dispatched upon request by the requester of the dispatching can also function as a lottery. As a result, the reading rate of advertising and the saving rate of the postcard is further improving, and in addition, the usage of the dispatching service of the present invention can be promoted.

Additionally, the present invention is a printed matter dispatching method using a multiplicity of terminals, and a printed matter dispatching server connected to said multiplicity of terminals via a network. Said printed matter dispatching method is characterized by executing: a dispatch request information receiving step in which said printed matter dispatching server receives the dispatch request information from said terminals; an advertising data extraction step in which said printed matter dispatching server extracts advertising data from the advertising information storage means based on said dispatch request information; and an integrating printing step in which said printed matter dispatching server prints the designated data contained in said dispatch request information and said extracted advertising data on the dispatching medium in an integrated manner.

The printed matter dispatching method of the present invention is further characterized by executing a request screen data transmission step in which said printed matter dispatching server transmits the request screen data for entry of said dispatch request information to said terminals.

In addition in the printed matter dispatching method of the present invention, said request screen data is characterized by being comprised of at least the sender's data entry means, the recipient's data entry means and the communication data entry means.

The printed matter dispatching method of the present invention is additionally characterized by executing: a request screen data transmission step in which, using a request receiving server connected to said printed matter dispatching server via a network, said request receiving server transmits said request screen data to said terminals; a dispatch request information receiving step in which said request receiving server receives the dispatch request information from said terminals; and a dispatch request forwarding step in which said request receiving server forwards said received dispatch request information to said printed matter dispatching server.

The printed matter dispatching method of the present invention is further characterized by executing: a dispatch history saving step in which said printed matter dispatching server saves the recipient data included in said dispatch request information by relating it to the requester of the dispatching; and a list screen data transmission step in which said printed matter dispatching server transmits the list screen data from the dispatch history that corresponds to the request from said terminals.

The printed matter dispatching method of the present invention is additionally characterized by executing a log-on screen data transmission step that transmits the log-on screen data that requests at least the entry of a password to said terminals, when said printed matter dispatching server receives said list screen data transmission request from said terminals, and a transmission authorization step that authorizes the transmission of said list screen data when the correct password is entered.

In addition, the printed matter dispatching method of the present invention is characterized such that said printed matter dispatching server executes a recipient selection entry step in which the recipient data selected from the list screen of the dispatch history is used as the current recipient data for the dispatch request information.

Furthermore, the printed matter dispatching method of the present invention is characterized such that said printed matter dispatching server executes an attribute information entry request step that requests the entry of attribute information about the recipient even if the recipient data selected from the list screen of the dispatch history is used as the current recipient data for the dispatch request.

Moreover, the printed matter dispatching method of the present invention is characterized by executing a preview screen data transmission step in which said printed matter dispatching server transmits the preview screen data to display the printing content prior to the execution of the printing of the dispatching medium by said integrating printing means, to said terminals.

In addition, the printed matter dispatching method of the present invention is characterized such that said preview screen data comprises a process selection means that selects the printing execution process, the print cancellation process or the print content correction process.

The printed matter dispatching method of the present invention is characterized such that said dispatching medium is a postcard or letter.

Furthermore, in the printed matter dispatching method of the present invention, said integrating printing step prints a lottery number on the dispatching medium.

Additionally the present invention is a printed matter dispatching server that is connected to a multiplicity of terminals via a network. Said printed matter dispatching server is characterized by comprising an advertising data storage means that stores multiple advertising data, a dispatch request information accepting means that receives dispatch request information from said terminals, an advertising data extracting means that extracts advertising data from said advertising information storage means based on said dispatch request information, and an integrating printing means that prints the designated data included in said dispatch request information and said extracted advertising data in an integrated manner.

In addition, the printed matter dispatching server of the present invention is characterized by comprising a request screen data transmission means that transmits request screen data for entering said dispatch request information, to said terminals.

Moreover, in the printed matter dispatching server of the present invention, said request screen data is characterized by comprising at least a sender data entry means, a recipient data entry means and a communication data entry means.

In the printed matter dispatching server of the present invention, the request receiving server that is connected to said terminals and said printed matter dispatching server via a network is further characterized by comprising a dispatch request information receiving means that receives the accepted dispatch request information.

The printed matter dispatching server of the present invention is characterized by additionally comprising a dispatch history saving means that saves recipient data included in said dispatch request information by relating it to the requester of the dispatching, and a list screen data transmission means that transmits the list screen data of the dispatch history that corresponds to the request from said terminals.

The printed matter dispatching server of the present invention is characterized by further comprising a log-on screen data transmission means that transmits log-on screen data that requests an entry of at least a password when a transmission request of said list screen data is received from said terminal, and a transmission authorization means that authorizes the transmission of said list screen data when the entered password is correct.

The printed matter dispatching server of the present invention is further characterized by comprising a recipient selection entry means that uses recipient data selected from the list screen of the dispatch history as the current recipient data for the dispatching request information.

The printed matter dispatching server of the present invention is additionally characterized by comprising an attribute entry request means that requests the entry of the attribute information of the recipient even in the case the recipient data selected in the list screen of the dispatch history is used as the current recipient data of the dispatch request information.

The printed matter dispatching server of the present invention is further characterized by comprising a preview screen data transmission means that transmits preview screen data to display the print content prior to printing of the dispatching medium by said integrating printing means.

In the printed matter dispatching server of the present invention, said preview screen data is characterized by comprising a process selection means that selects a print executing process, a print cancellation process or a print content correction process.

In the printed matter dispatching server of the present invention, said dispatching medium is characterized by being a postcard or letter.

In the printed matter dispatching server of the present invention, said integrating printing means is characterized by printing a lottery number on the dispatching medium.

In addition, the present invention is a request receiving server connected to multiple terminals and a printed matter dispatching server via a network, wherein, said request receiving server is characterized by comprising a request screen data transmission means that transmits request screen data to said terminal, a dispatch request information receiving means that receives dispatch request information from said terminals, and a dispatch request information forwarding means that forwards said received dispatch request information to said printed matter dispatching server.

The present invention is a storage medium readable by a computer, wherein, said storage medium stores program codes that operate said printed matter dispatching server as the variety of means described in Claims 25 to 36.

The present invention is a storage medium readable by a computer, wherein, said storage medium stores program codes that operate said request receiving server as the variety of means described in claim 37.

### BRIEF DESCRIPTION OF DRAWINGS

FIG. 1 is a block diagram of a printed matter dispatching system.

FIG. 2 is a schematic view of a dispatch request screen.

FIG. 3 is a schematic view of a preview screen.

FIG. 4 is a schematic view of a log-on screen.

FIG. 5 is a schematic view of a dispatch history list screen.

FIG. 6 is a flowchart that shows the procedure for dispatching a postcard that is directly requested to the printed matter dispatching server (without logging on).

FIG. 7 is a flowchart that shows the procedure for dispatching a postcard that is directly requested to the printed matter dispatching server (with logging on).

FIG. 8 is a flowchart that shows the procedure for dispatching a postcard that is requested via the request receiving server.

### THE BEST MODE FOR CARRYING OUT THE INVENTION

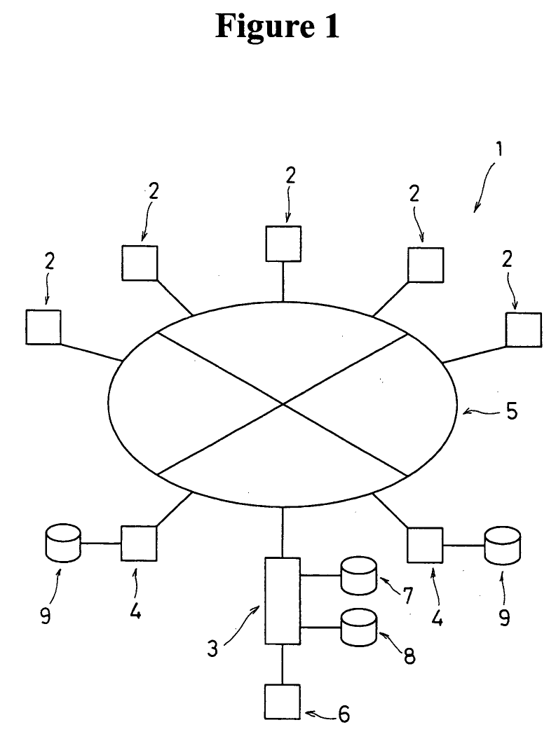

Next, the mode for carrying out the present invention is described by referring to drawings. In the drawings, 1 is a printed matter dispatching system. Said printed matter dispatching system 1 is, as shown in FIG. 1, comprised of a multiplicity of terminals 2, a printed matter dispatching server 3, a request receiving server 4, and a network 5 such as the Internet that connects them with each other.

The terminals 2 comprise personal computers having a network connection and homepage browsing functions, mobile information terminals and mobile phones, etc. For example, terminals 2 may consist of a personal computer comprising a CPU, ROM, RAM, hard disk, network interface, monitor, keyboard and mouse etc., and said hard disk stores programs such as a terminal operation system and home page browsing software (hereinafter referred to as a browser).

The printed matter dispatching server 3 comprises a CPU, ROM, RAM, hard disk, network interface, printer (printing device) 6, etc. The hard disk stores programs such as the server operation system, web server software and database software, files such as HTML files to write homepages, and databases such as advertising database 7 and dispatch history database 8. These programs and data operate the printed matter dispatching server 3 as the printed matter dispatching service site that dispatches printing and dispatching of postcards upon request from terminals 2. The advertising database 7 stores a variety of advertising data provided from the advertiser, and each advertising database is configured with the attribute data (extracting conditions) of the recipients with a potentially high advertising effect. In addition, dispatch history database 8 stores data on the recipients of the dispatched postcards, and each recipient data item is stored by being related to the requester of the dispatch (sender data).

The request receiving server 4 comprises a CPU, ROM, RAM, hard disk, network interface, etc. Said hard disk stores programs such as the server operation system, web server software, database software, files such as HTML files that write homepages and databases such as address book database 9. These programs and data operate the request receiving server 4 as, for example, a community site and request receiving site. In other words, the request receiving server 4 is originally managed for a purpose other than a request receiving site, and it is desirable to maintain, for example, an address book of the members of the community. Functionality as a request receiving site is provided to the request receiving server 4 via an arbitrary storage medium, and by installing programs and data stored in said storage medium, the request receiving server 4 also serves as the request receiving site.

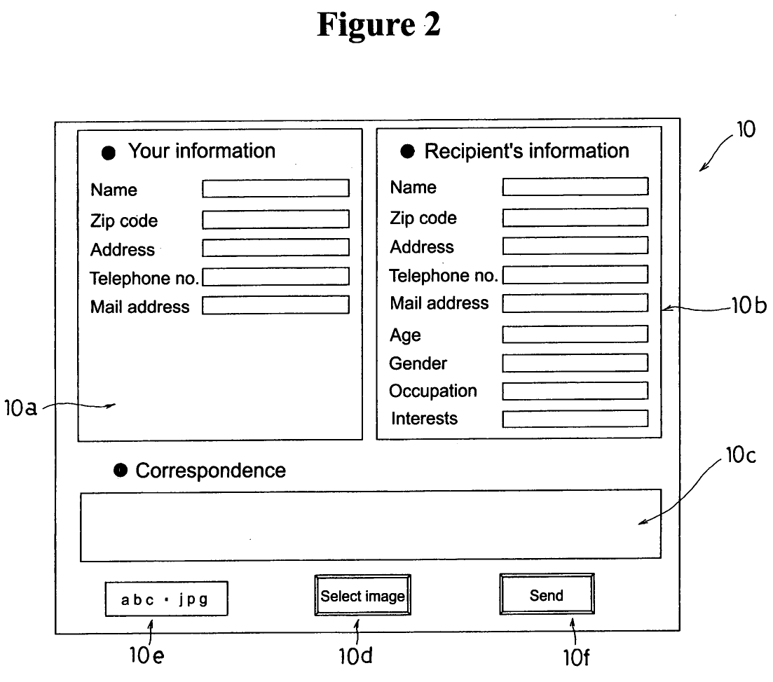

Next, each display screen of terminals 2 is described by referring to the drawings. Here, each display screen is displayed on the monitor by a browser executing on terminals 2 by receiving screen data (HTML files) from servers 3 and 4. FIG. 2 is a schematic view of a dispatch request screen. As shown in the figure, dispatch request screen 10 comprises sender information entry section 10a, where the sender (requester of the dispatching) information is entered, the recipient information entry section 10b where recipient information is entered, a communication entry box 10c where communication body (text data) is entered, an image selection button 10d to select the image file, an image file display box 10e to display the name of the image file, and send button 10f to send the entered dispatch request information to servers 3 and 4. In addition, in the sender information entry section 10a, there are entry boxes to enter the sender's name, zip code, address, telephone number, mail address, etc., while in the recipient information entry section 10b there are entry boxes to enter the recipient's name, zip code, address, telephone number, mail address, age, gender, occupation, interests, etc. When image selection button 10d is clicked, a separate screen that lists the saved image files on the hard disk, etc., of terminal 2 is displayed and the image file name that is selected from said screen is displayed in image file display box 10e.

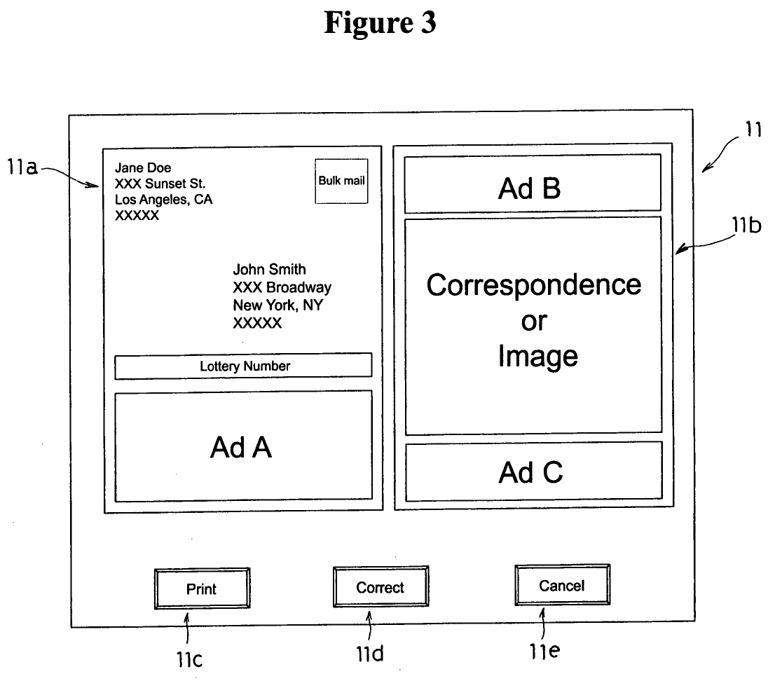

FIG. 3 is a schematic view of the preview screen. As shown in the figure, preview screen 11 comprises a front side display 11a that displays the front side of the postcard to be printed, a back side display 11b that displays the back side of the postcard to be printed, a print execution button 11c to transmit the print command to the printed matter dispatching server 3, a content correction button 11d that transmits a correction command to the printed matter dispatching server 3, and a print cancel button 11c that transmits a print cancel command to the printed matter dispatching server 3. Also, in the front side display 11a, in addition to the recipient data (zip code, address, name) and sender data (name, zip code, address), the advertising data A extracted from the advertising database 7 based on recipient data and an automatically generated lottery number (serial number) are displayed in a designated layout. At the same time, in the back side display 11b, in addition to the correspondence or image that was entered in said dispatch request screen 10, advertising data B and C extracted from the advertising database 7 are displayed in the designated layout.

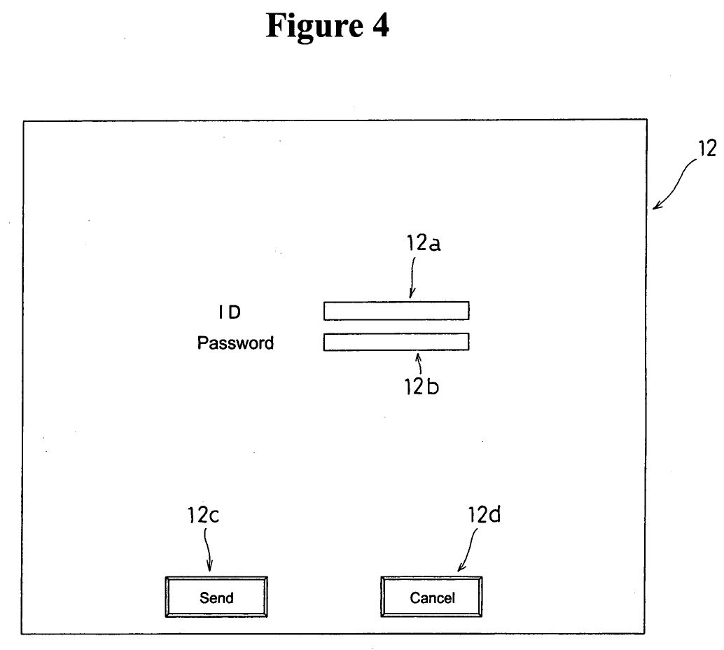

FIG. 4 is a schematic view of the log-on screen. As shown in the figure, the log-on screen 12 comprises an ID entry box 12a where the ID of the requester of the dispatch is entered, a password entry box 12b where a password that is set in advance is entered, a send button 12c to transmit the entered ID and password to the printed matter dispatching server 3 and a cancel button 12d to cancel the log-on. When the printed matter dispatching server 3 identifies the terminals 2 with a cookie (terminal information obtainable by the server), the entry in the ID entry box 12a can be omitted.

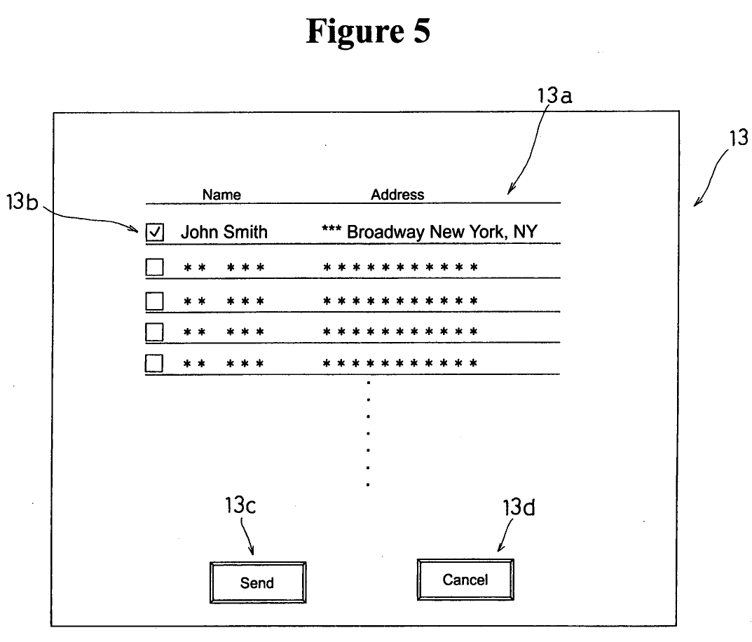

FIG. 5 is a schematic view of the dispatch history list screen. As shown in the figure, the dispatch history list screen 13 comprises a list display 13a that lists the dispatch history (recipient data for the postcards dispatched in the past) of the logged-on requester of the dispatching, a check box 13b in order to select the designated recipient data from a list, a send button 13c to request dispatching to the printed matter dispatching server 3 by selecting the checked recipient data to be the current recipient data of the postcard to be dispatched, and a cancel button 13d to cancel the list display.

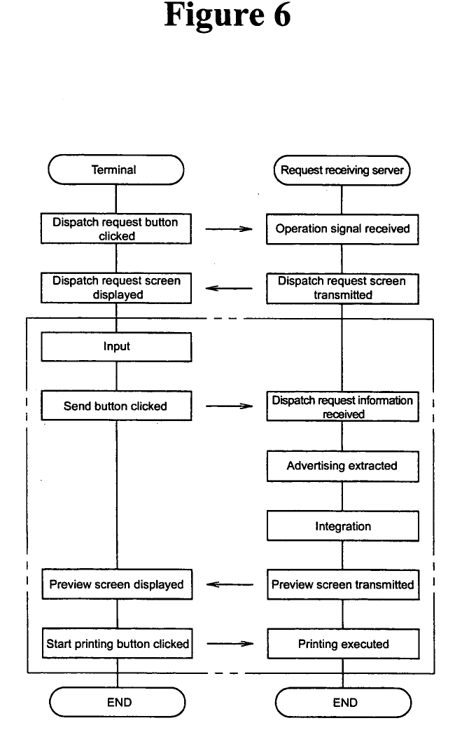

Next, the operation of the terminals 2, the printed matter dispatching server 3 and request receiving server 4 is described by referring to the flowcharts. In each flowchart, procedures prior to the top page of servers 3 and 4 being displayed on the monitor screen of terminal 2 are omitted. FIG. 6 is a flowchart that shows the procedure in the case the dispatching of the postcard is directly requested to the printed matter dispatching server (without a log-on). As shown in the figure, when the dispatch request button is clicked in the top screen of the printed matter dispatching server 3 displayed on terminal 2, a button operation signal is transmitted to the printed matter dispatching server 3. The printed matter dispatching server 3 that receives this signal transmits the screen data (HTML file) of said dispatch request screen 10 to a terminal 2, and terminal 2 displays the dispatch request screen 10. On this screen, the sender data, recipient data and communication data (text or image) are entered and then clicking send button 11f transmits the entered data to the printed matter dispatching server 3 as the dispatch request information. The printed matter dispatching server 3 that receives the dispatch request information selects advertising data from the advertising database 7 based on the attribution data included in the recipient data (address, age, gender, occupation, interests) and extracts the most appropriate advertising data. The extracted advertising data is integrated in the layout of the print data for the postcard along with the recipient data, sender data and lottery number. Furthermore, the printed matter dispatching server 3 creates screen data for said preview screen 11 in accordance with the integrated print data for the postcard printing, and transmits it to the terminal 2. The terminal 2 that receives it displays a preview screen 11, and then when the print execution button 11c is clicked after checking the printing content, the operation signal is transmitted to the printed matter dispatching server 3. The printed matter dispatching server 3 that receives it executes the printing of the postcard in accordance with said print data. The printed postcards are brought to the Post Office by a person and dispatched as such as bulk mail. When the content correction button 11d is clicked on said preview screen 11, the printed matter dispatching server 3 transmits the already entered dispatch request screen data to the terminal 2 and requests the corrections of the dispatch request information.

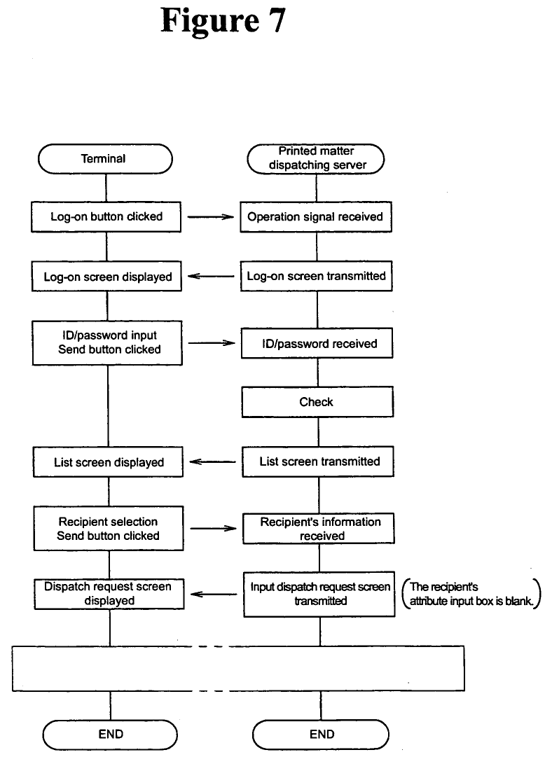

FIG. 7 is a flowchart that shows the procedure in the case the dispatching of the postcards is directly requested to the printed matter dispatching server (with a log-on). As shown in the figure, when the log-on button is clicked on the top screen of the printed matter dispatching server 3 displayed on terminal 2, the button operation signal is transmitted to the printed matter dispatching server 3. The printed matter dispatching server 3 that receives this signal transmits the screen data of said log-on screen 12 to terminal 2, and terminal 2 displays the log-on screen. On this screen, when send button 12c is clicked after the ID and password are entered, the entered data is transmitted to the printed matter dispatching server 3 as the log-on information. The printed matter dispatching server 3 that receives the log-on information checks the ID and password, and if it is correct, extracts the dispatch history data related to the ID (requester of the dispatching) from the dispatch history database 8. The extracted dispatch history data is read into the screen data of said dispatch history list screen 13 and transmitted to terminal 2. Terminal 2 that receives it displays a dispatch history list screen 13, and when the send button 13c is clicked after selecting the recipient to send to this time, the selected data is transmitted to the printed matter dispatching server 3. The printed matter dispatching server 3 that receives it transmits the dispatch request screen data entered with the sender data and recipient data to terminal 2. At this time, the printed matter dispatching server 3 extracts the necessary data from the dispatch history database 8 into the entry boxes, however, the entry boxes for age, gender, occupation and interests are left blank. By doing this, it requests the entry of the attribute information for the recipient from the requester of the dispatching allowing the obtaining of the latest attribute information for the recipient. The process thereafter is identical with the hypothetical lined portion so that the description of FIG. 6 can be referenced.

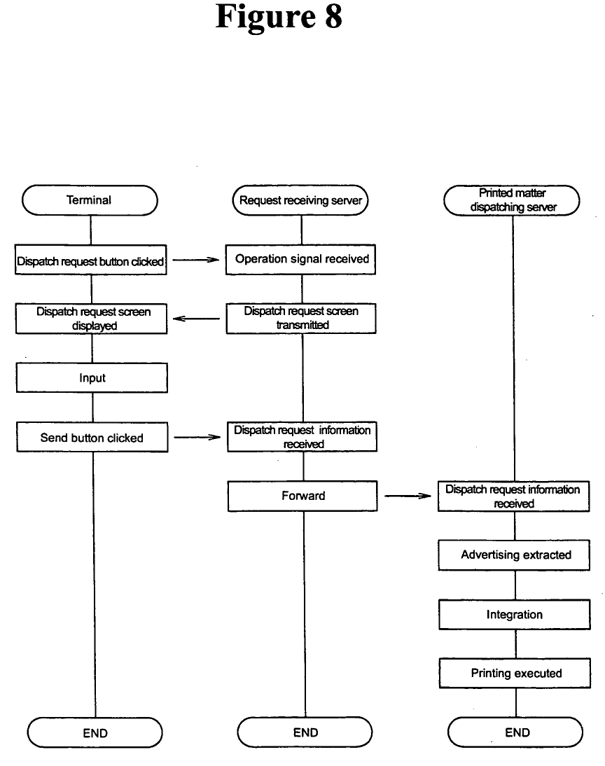

FIG. 8 is a flowchart showing the procedure in the case the dispatching of the postcard is requested via a request receiving server. As shown in the figure, when a dispatch request button is clicked on the top screen of the request receiving server 4 displayed at terminal 2, a button operation signal is transmitted to the request receiving server 4. The request receiving server 4 that receives this signal transmits the screen data of said dispatch request screen to terminal 2, and terminal 2 displays the dispatch request screen 10. On this screen, after entering the sender data, the recipient data and the communication data (text or image), when send button 11f is clicked, the entered data is transmitted to the request receiving server 4 as the dispatch request information. The request receiving server 4 that receives the dispatch request information checks the content of the dispatch request information, and then forwards the dispatch request information to the printed matter dispatching server 3. The printed matter dispatching server 3 that receives it selects the advertising data from the advertising database 7 based on the attribute data included in the recipient data, and then extracts the most appropriate advertising. The extracted advertising data is integrated in the layout as the print data for the postcard along with the recipient data, the sender data and a lottery number, and then based on this print data, the postcard is printed. The printed postcard is brought to the Post Office by a person, and then dispatched as such as bulk mail.

As structured above, in the printed matter dispatching system 1 comprising a multiplicity of terminals 2 and printed matter dispatching server 3 that is connected to said multiplicity of terminals 2 via network 5, the printed matter dispatching server 3 comprises an advertising database 7 that stores a multiplicity of advertising data, as well as, executing a process to receive dispatch request information from terminal 2, a process to extract advertising data from advertising database 7 based on the received dispatch request information, and a process to print the designated data included in the dispatch request information and the extracted advertising data on a postcard in an integrated manner. Therefore, when sending a postcard, requests for a dispatch to the printed matter dispatching server 3 from terminal 2 at hand allows the printed matter dispatching server 3 to dispatch a postcard by printing the designated data included in the dispatch request information, and as a result, requesters of the dispatch can avoid the inconvenience of purchasing postcards, and dropping them off at the mail box during the sending of a postcard.

In addition, advertising data is printed in an integrated fashion on the postcard so that the printed matter dispatching service can be provided inexpensively or free of charge when the administrator of the printed matter dispatching server 3 collects an advertising fee from the advertiser.

Furthermore, because it is a postcard from an acquaintance, it not only has a high probability that the recipients will thoroughly read the advertising but also will kept it. As a result, a great improvement in the advertising effect can be possible.

Moreover, the advertising data to be printed in an integrated manner can be selected based on the recipient's attribute information such as the address, age, gender, occupation or interests that were entered by the requester of the dispatching, allowing a further improved advertising effect.

Additionally, the printed matter dispatching server 3 transmits dispatch request screen data for entering the dispatch request information to terminals 2 allowing a dispatch request to be carried out on the designated screen displayed on a personal computer or mobile phone, and consequently this further simplifies the dispatching operation for postcards.

Further, a dispatch request screen 10 comprises a sender information entry section 10a, a recipient information entry section 10b and a communication body entry box 10c so that essential data for sending a postcard can be obtained, and in addition, image data can be selected as the communication data allowing the sending of postcards printed with photos, illustrations and handwriting, etc., from an environment without a printer.

In addition, the printed matter dispatching system 1 comprises a request receiving server 4 that receives a dispatch request from the terminals 2 and transfer it to the printed matter dispatching server 3, allowing the reception of dispatch requests using a variety of sites existing on networks such as the Internet, and therefore, a great increase in the number of dispatch requests can be expected, in particular, when dispatch requests are received at a site that provides communication. Also, when the address data, etc., stored in the request receiving server 4 is forwarded, the entry operation of the requester of the dispatching can be significantly simplified.

Moreover, the printed matter dispatching server 3 stores recipient data included in the dispatch request information as a dispatch history by relating it to the requester of the dispatching, and displays said dispatch history as a list in correspondence with the request from terminal 2, and therefore, the entry operation of the requester of the dispatching can be significantly simplified in the case a postcard is sent again to a previously dispatched to recipient.

Furthermore, the printed matter dispatching server 3 requests the entry of an ID and password prior to the display of the list of dispatch history, thereby preventing the leakage of the dispatch history, which is personal information.

Additionally, the printed matter dispatching server 3 treats the recipient data selected from the list of dispatch history as the current recipient data of the dispatch request information, eliminating the entry of recipient data, and consequently the entry operation of the requester of the dispatching can be significantly simplified.

Further, the printed matter dispatching server 3 requires the entry of the attribute information of the recipient even when the recipient data selected from the list screen of dispatching history is used as the current recipient data for the dispatch request, allowing the obtaining of the latest attribute information about the recipient. As a result, a higher matching precision of the advertising data can be expected compared to the case the advertising data is extracted based on the attribute information entered in the past.

In addition, the printed matter dispatching server 3 displays a preview of the print content prior to the printing of a postcard allowing the print content to be confirmed before dispatching. Also, the advertising content that will be printed in an integrated manner will be displayed in the preview allowing the requester of the dispatching to select the advertising.

Moreover, in the preview screen, the print execution process, print cancellation process or print content correction process can be selected improving the convenience of the requester of the dispatching.

Furthermore, a highly usable postcard is used as the dispatching medium and advertising is printed on said dispatching medium in an integrated manner allowing an enormous advertising medium to be constructed.

Also, a lottery number is printed on the postcard during the integrating printing, and therefore the postcard dispatched upon request by the requester of the dispatching can also serve as a lottery card. As a result, not only the rate of thoroughly reading the advertising and keeping the postcard can be further improved but also the use of the dispatch service of the present invention can be promoted.

It goes without saying that the present invention is not limited to the modes described above and for example, it need not be said that the dispatching medium is not limited to being a postcard, so that a letter or private courier service can be used. In addition, it can be configured so that a single dispatching request allows the dispatching of postcards, etc., to a multiplicity of recipients. In this case, the convenience of the requester of the dispatching can be improved as well as the usage of the dispatching service can be promoted. Furthermore, a lottery number can be printed as a part of the advertising data, allowing each advertiser to individually carry out a sales promotion campaign using a lottery number. Moreover, the preview screen does not necessarily have to display the entire printing image, and it is acceptable to display a preview of, for example, the communication body only. Further, the printed matter dispatching server does not need to be a single server, for instance, the printed matter dispatching server can comprise a receiving server that receives the dispatch request, and a printing server that receives the request information from said receiving server and executes the printing.

### Industrial Applicability

The printed matter dispatching system of the present invention is useful to the sender who sends a private postcard, etc., and an advertiser who sends direct mail and it allows an easy dispatching of private postcards., etc., from a terminal connected to a network such as the Internet. In addition, by printing advertising on the dispatching postcard, etc., in an integrated manner, not only does it allow the carrying out of highly effective advertising but also it provides a dispatching service for postcards, etc., inexpensively or free of charge with the advertising fee being collected from advertisers.

We claim:

1. A printed matter dispatching system comprising multiple terminals and a printed matter dispatching server that is connected to said multiple terminals via a network wherein;
said printed matter dispatching server comprises:
an advertising storage means that stores multiple advertising data;
a dispatch request information receiving means that receives dispatch request information from said terminals;
an advertising extraction means that extracts advertising data from said advertising storage means based on said dispatch request information, and;
an integrating printing means that prints the designated data included in said dispatch request information and said extracted advertising data on the dispatching medium in an integrated manner.

2. A printed matter dispatching system in accordance with claim 1 wherein, said printed matter dispatching server comprises a request screen data transmission means that transmits the request screen data for entering said dispatch request information to said terminals.

3. A printed matter dispatching system in accordance with claim 2 wherein, said request screen data is characterized by comprising at least a sender data entry means, a recipient data entry means and a communication data entry means.

4. A printed matter dispatching system in accordance with claims 1 through 3 wherein, said printed matter dispatching system further comprises a request receiving server that is connected to said terminals and said printed matter dispatching server via a network wherein, said request receiving server is characterized by comprising a request screen data transmission means that transmits said request screen data to said terminals, a dispatch request information receiving means that receives dispatch request information from said terminals, and a dispatch request information forwarding means that forwards said received dispatch request information to said printed matter dispatching server.

5. A printed matter dispatching system in accordance with claims 1 though 4 wherein, said printed matter dispatching server is characterized by further comprising a dispatch history storage means that saves recipient data included in said dispatch request information by relating it to the requester of the dispatching and a list screen data transmission means that transmits the list screen data of the dispatch history that corresponds to the request from said terminals.

6. A printed matter dispatching system in accordance with claim 5 wherein, said printed matter dispatching server is characterized by further comprising a log-on screen data transmission means that transmits log-on screen data that requests the entry of at least a password, when a transmission request of said screen data is received from said terminal, and a transmission authorization means that authorizes the transmission of said list screen data when the entered password is correct.

7. A printed matter dispatching system in accordance with claims 5 and 6 wherein, said printed matter dispatching server is characterized by further comprising a recipient selection entry means that uses recipient data selected from the list screen of the dispatch history as the current recipient data of the dispatch request information.

8. A printed matter dispatching system in accordance with claim 7 wherein, said printed matter dispatching server is characterized by further comprising an attribute entry request step that requests the entry of attribute information about the recipient even when said printed matter dispatching server uses the recipient data selected from the list screen of the dispatching history as the current recipient data for the dispatch request information.

9. A printed matter dispatching system in accordance with claims 1 to 8 wherein, said printed matter dispatching server is characterized by further comprising a preview screen data transmission means that transmits preview screen data for displaying the print content to said terminals prior to the printing of the dispatching medium by said integrating printing means.

10. A printed matter dispatching system in accordance with claim 9 wherein, said preview screen data is characterized by comprising a process selection means that selects the print execution process, a print cancellation process or a print content correction process.

11. A printed matter dispatching system in accordance with claims 1 to 10 wherein, said dispatching medium is characterized by being a postcard or letter.

12. A printed matter dispatching system in accordance with claims 1 to 11 wherein, said integrating printing means is characterized by printing a lottery number on the dispatching medium.

13. A printed matter dispatching method using a multiplicity of terminals and a printed matter dispatching server that is connected to said multiplicity of terminals via a network wherein;
said printed matter dispatching method comprises:
a dispatch request information receiving step in which said printed matter dispatching server receives dispatch request information from said terminals;
an advertising data extraction step in which said printed matter dispatching server extracts advertising data from an advertising information storage means in accordance with said dispatch request information and;
an integrating printing step in which said printed matter dispatching server prints the designated data included in said dispatch request information and said extracted advertising data in an integrated manner.

14. A printed matter dispatching method in accordance with claim 13 wherein, said printed matter dispatching server is characterized by executing a request screen data transmission step that transmits request screen data for entering said dispatch request information to said terminal.

15. A printed matter dispatching method in accordance with claim wherein, said request screen data is characterized by comprising at least a sender data entry means, a recipient data entry means and a communication body data entry means.

16. A printed matter dispatching method in accordance with claims 13 and 15 being further characterized by using a request receiving server that is connected to said terminal and said printed matter dispatching server via a network, wherein said request receiving server executes a request screen data transmission step that transmits said request screen data to said terminal, and a dispatch request information receiving step that receives the dispatch request information from said terminal, and a dispatch request information forwarding step that forwards the dispatch request information received by said request receiving server to said printed matter dispatching server.

17. A printed matter dispatching method in accordance with claims 13 and 16 wherein, said printed matter dispatching server is characterized by further executing a dispatch history saving step that saves the recipient data included in said dispatch request information by relating it to the requester of the dispatching, and a list screen transmission step in which said printed matter dispatching server transmits the list screen data of the dispatch history that corresponds to the request from said terminal.

18. A printed matter dispatching method in accordance with claim 17 being further characterized such that when said printed matter dispatching server receives a transmission request for said list data from said terminal, it executes a log-on screen data transmission step that transmits log-on screen data that requests the entry of at least a password, and a transmission authorization step that authorizes the transmission of said list data when the entered password is correct.

19. A printed matter dispatching method in accordance with claims 17 and 18 wherein, said printed matter dispatching server is characterized by further executing a recipient selection entry step that uses the recipient data selected from the list screen of the dispatch history as the current recipient data of the dispatch request information.

20. A printed matter dispatching method in accordance with claim 19 being characterized such that, even when said printed matter dispatching server uses the recipient data selected from the list screen of the dispatching history as the current recipient data of the dispatch request information, said printed matter dispatching method executes an attribute entry request step that requests the entry of the attribute information of the recipient.

21. A printed matter dispatching method in accordance with claims 13 to 20 wherein, said printed matter dispatching method is characterized by further executing a preview screen data transmission step in which said printed matter dispatching server transmits preview screen data to said terminal prior to the printing of the dispatching medium by said integrating printing means.

22. A printed matter dispatching method in accordance with claim 21 wherein, said preview screen data is characterized by further comprising a process selection means that selects a print executing process, a print cancellation process or a print content correction process.

23. A printed matter dispatching method in accordance with claims 13 to 22 wherein, said dispatching medium is characterized by being a postcard or letter.

24. A printed matter dispatching method in accordance with claims 13 to 23 wherein, said integrating printing step is characterized by printing a lottery number on the dispatching medium.

25. A printed matter dispatching server that is connected to a multiplicity of terminals via a network wherein;
said printed matter dispatching server comprises:
an advertising data storage means that stores a multiplicity of advertising data;
a dispatch request information receiving means that receives dispatch request information from said terminals;
an advertising data extracting means that extracts advertising data from said advertising information storage means in accordance with said dispatch request information, and;
an integrating printing means that prints the designated data included in said dispatch request information and said extracted advertising data on the dispatching medium in an integrated manner.

26. A printed matter dispatching server wherein, said printed matter dispatching server is characterized by further comprising a request screen data transmission means that transmits request screen data for entering said dispatch request information to said terminal.

27. A printed matter dispatching server in accordance with claim 26 wherein, said request screen data is characterized by comprising, as a minimum, a sender data entry means, a recipient data entry means and a communication body data entry means.

28. A printed matter dispatching server in accordance with claims 25 to 27 wherein, said printed matter dispatching server is characterized by further comprising a dispatch request information receiving means that receives dispatch request information received by the request receiving server connected to said terminals and said printed matter dispatching server via a network.

29. A printed matter dispatching server in accordance with claims 25 to 28 wherein, said printed matter dispatching server is characterized by further comprising a dispatch history saving means that saves recipient data included in said dispatch request information by relating it with the requester of the dispatching, and a list screen data transmission means that transmits the list screen data of the dispatch history that corresponds to the request from said terminals.

30. A printed matter dispatching server in accordance with claim 29 wherein, said printed matter dispatching server is characterized by further comprising a log-on screen transmission means that transmits log-on screen data that requests the entry of at least a password when a transmission request for said list screen data is received from said terminals, and a transmission authorization means that authorizes the transmission of said list screen data when the entered password is correct.

31. A printed matter dispatching server in accordance with claims 29 to 30 wherein, said printed matter dispatching server is characterized by additionally comprising a recipient selection entry means that uses the recipient data selected from the list screen of the dispatch history as the current recipient data for the dispatch request information.

32. A printed matter dispatching server in accordance with claim 31 wherein, said printed matter dispatching server is characterized by further comprising an attribute information entry request means that requests the entry of attribute information related to the recipient even when the recipient data selected from the list screen of the dispatch history is used as the current recipient data for the dispatch request information.

33. A printed matter dispatching server in accordance with claims 25 to 32 wherein, said printed matter dispatching server is characterized by further comprising a preview screen data transmission means that transmits preview screen data for displaying the print content prior to the printing of the dispatching medium by said integrating printing means to said terminal.

34. A printed matter dispatching server in accordance with claim 33 wherein, said preview screen data is characterized by comprising a process selection means that selects a print execution process, a print cancellation process or a print content correction process.

35. A printed matter dispatching server in accordance with claims 25 to 35 wherein, said dispatching medium is characterized by being a postcard or letter.

36. A printed matter dispatching server in accordance with claims 25 to 35 wherein said integrating printing means is characterized by printing a lottery number on the dispatching medium.

37. A request receiving server that is connected to a multiplicity of terminals and a printed matter dispatching server via a network wherein:
said request receiving server comprises
a request screen data transmission means that transmits request screen data to said terminals;
a dispatch request information receiving means that receives dispatch request information from said terminal, and;
a dispatch request information forwarding means that forwards said received dispatch request information to said printed matter dispatching server.

38. A storage medium readable by computers wherein, said storage medium is characterized by storing program codes that operate said printed matter dispatching server for each means described in claims 25 to 36.

39. A storage medium readable by computers wherein, said storage medium is characterized by storing program codes that operate said request receiving server for each means described in claim 37.
